(19) United States
(12) Patent Application Publication
(10) Pub. No.: US 2008/0208573 A1
(43) Pub. Date: Aug. 28, 2008

(54) Speech Signal Coding

(75) Inventors: Bizhan Karimi-Cherkandi, Boca Raton, FL (US); Farrokh Mohammadzadeh Kouchri, Boca Raton, FL (US)

Correspondence Address: BELL, BOYD & LLOYD, LLP, P.O. BOX 1135, CHICAGO, IL, 60690, US

(73) Assignee: Nokia Siemens Networks GmbH & Co. KG, DE (DE)

(21) Appl. No.: 11/998,000

(22) PCT Filed: Aug. 2, 2006
(86) PCT No.: PCT/EP2006/064940

§ 371 Date: Feb. 5, 2008

Related U.S. Application Data
(60) Provisional application No. 60/705,772, filed on Aug. 5, 2005.

(51) Int. Cl. G10L 19/00; G10L 21/00; G10L 19/04

(52) U.S. Cl. 704/211; 704/270; 704/500; 704/E19.001; 704/E19.009

(57) ABSTRACT

The present invention relates to methods and apparatuses for speech signal encoding and decoding. In accordance with the invention, a discrete time speech signal is encoded by identifying a speech element in the speech signal. If the speech element is identified for the first time, the encoder (108) creates a unique tag representing the speech element and an associating between the speech element and the unique tag in a memory and transmits the speech element in discrete time form and the tag and an indication that the tag is to represent the speech element to a decoder (118). If the speech element was identified before, the encoder (108) obtains a unique tag representing the speech element from the memory, removes the speech element from the speech signal and transmits the unique tag representing the speech element as obtained from the memory.

This application is related to and claims the benefit of commonly-owned U.S. Provisional Patent Application No. 60/705,772, filed Aug. 5, 2005, titled “Enhanced Compression” which is incorporated by reference herein in its entirety.

The present invention relates to a method and apparatus for speech signal encoding. The present invention also relates to a method and apparatus for speech signal decoding.

Telecommunications networks are currently evolving from traditional circuit based networks (PSTN=Public Switched Telephony Network) to packet based networks, wherein communication is facilitated by well-known voice-over-packet (VoP) mechanisms. A prominent example of VoP is voice over Internet Protocol (VoIP), wherein the well-established Internet Protocol (IP) is used as network layer protocol for conveying both signaling and voice.

In general, phone service via VoIP costs less than equivalent service from traditional sources. Some cost savings are due to using a single network to carry voice and data. Still, VoIP content, i.e. speech signals, consumes considerable amounts of bandwidth which is then not available for other applications. In a typical scenario involving a user using an asymmetric digital subscriber line (ADSL) technique having an upstream bandwidth of 128 kbit/s for connecting to the network, a single ITU-T G.711 encoded voice call having a bidirectional bandwidth requirement of roughly 90 kbit/s may consume more than half of the available upstream bandwidth.

While codecs with lower bandwidth requirements exist such as the ITU-T G.723.1, G.729 codecs or the GSM full-rate (FR), enhanced full-rate (EFR) or adaptive multi-rate (AMR) codecs, these lower bandwidth requirements are normally achieved at the expense of lower speech quality.

It is therefore an object of the present invention to provide a novel method and apparatus for encoding speech signals capable of reducing the bandwidth requirements of a given speech signal without significantly reducing the quality of the decoded speech signal. It is another object of the pre-sent invention to provide a corresponding method and apparatus for decoding speech signals.

In accordance with the foregoing objects, there is provided by a first aspect of the invention a method for encoding a discrete time speech signal, comprising:
identifying a speech element in the speech signal;
if the speech element is identified for the first time:
   creating a unique tag representing the speech element;
   creating an association between the speech element and the unique tag in a memory;
   transmitting the speech element in discrete time form and the tag and an indication that the tag is to represent the speech element;
otherwise obtaining a unique tag representing the speech element from the memory, removing the speech element from the speech signal and transmitting the unique tag representing the speech element as obtained from the memory.

In an embodiment, the tag representing the speech element may be chosen to comprise parameters indicating any or all of the following:
loudness of the represented speech element;
leading and/or trailing delay for reinserting the speech element into the discrete time speech signal;
a length indication indicating whether the full speech element or a fraction thereof is to be reinserted into the discrete time speech signal; and/or
an identifier identifying a speaker or an encoding device.

The speech element may be selected to comprise any or all of the following: entire words, syllables, and/or phonemes.

It is an advantage of the present invention that it allows to transmit a short tag as a representation for more frequently occurring speech elements (for example words such as “yes”, “no”, or phonemes such as “i”, “a”). A speech signal encoded using this method will have reduced bandwidth requirements. The method is “self learning” in that when a speech element is identified for the first time, it will be transmitted along with the unique tag to the decoder. The tag and the speech element represented by it are stored at the decoder, allowing the decoder to replace any further occurrence of the tag with the original speech element, thus allowing reconstruction of the speech signal. The present invention thus makes use of the fact that, particularly in spoken language, not only the vocabulary used is limited, but also the number of speech elements such as phonemes is even more limited than the vocabulary.

In accordance with the invention, there is also provided a network element serving a called party having means for performing the inventive method, and a user terminal attachable to a telecommunications network having means for performing the inventive method.

In another aspect, the invention provides a method for decoding speech signals encoded in accordance with the first aspect of the invention. The decoding method comprises:
determining if a received signal section comprises a tag, if no tag is received, inserting the signal section into the reconstructed speech signal;
if the tag is identified for the first time:
   extracting a corresponding speech element from the signal section;
   creating an entry in a memory for the tag and the corresponding speech element; and
   inserting the speech element into the reconstructed speech signal;
if the tag is already residing in memory:
   extracting a corresponding speech element from the memory; and
   inserting the speech element into the reconstructed speech signal.

In accordance with the invention, there are also provided network elements having means for performing either or both of the encoding and decoding aspects of the inventive method, and a user terminal attachable to a telecommunications network having means for performing either or both of the encoding and decoding aspects of the inventive method.

Embodiments of the invention will now be described in more detail with reference to drawings, wherein:

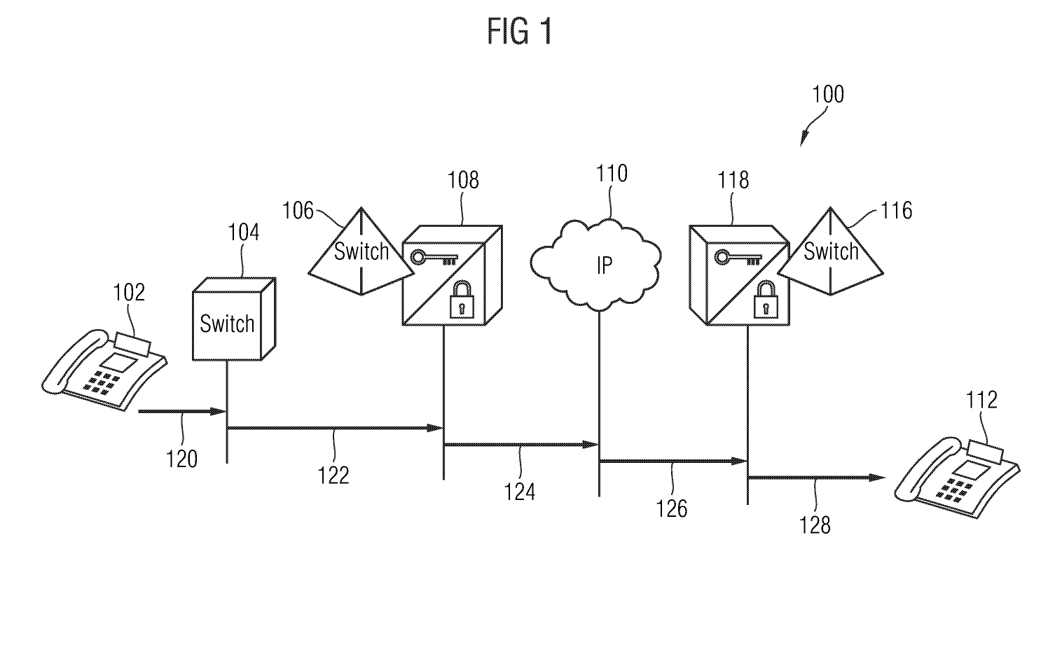

FIG. 1 schematically shows a network arrangement having a network element configured in accordance with the invention;

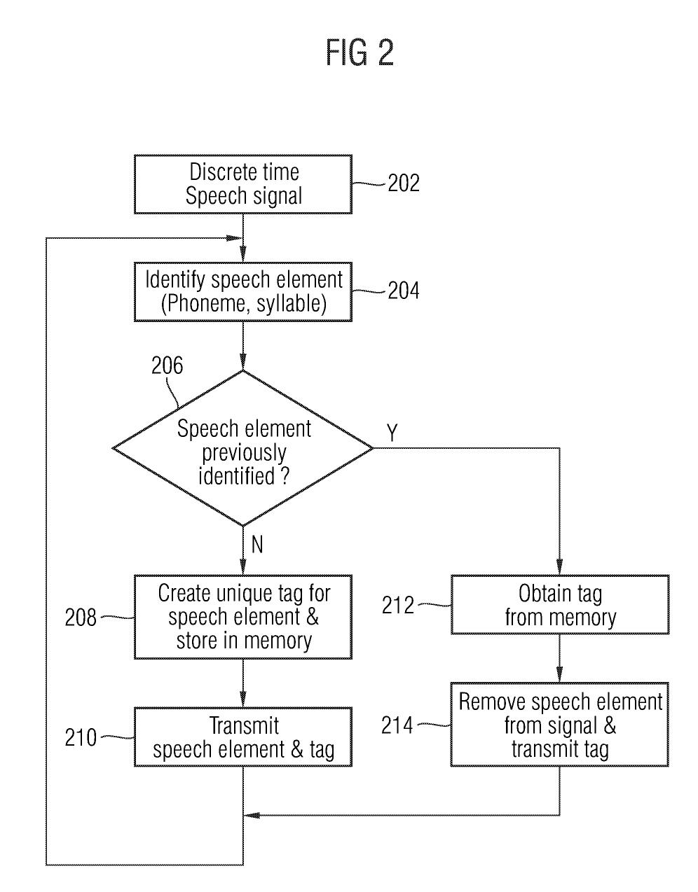

FIG. 2 is a flow diagram of the operation of an encoder in accordance with a preferred embodiment of the present invention; and

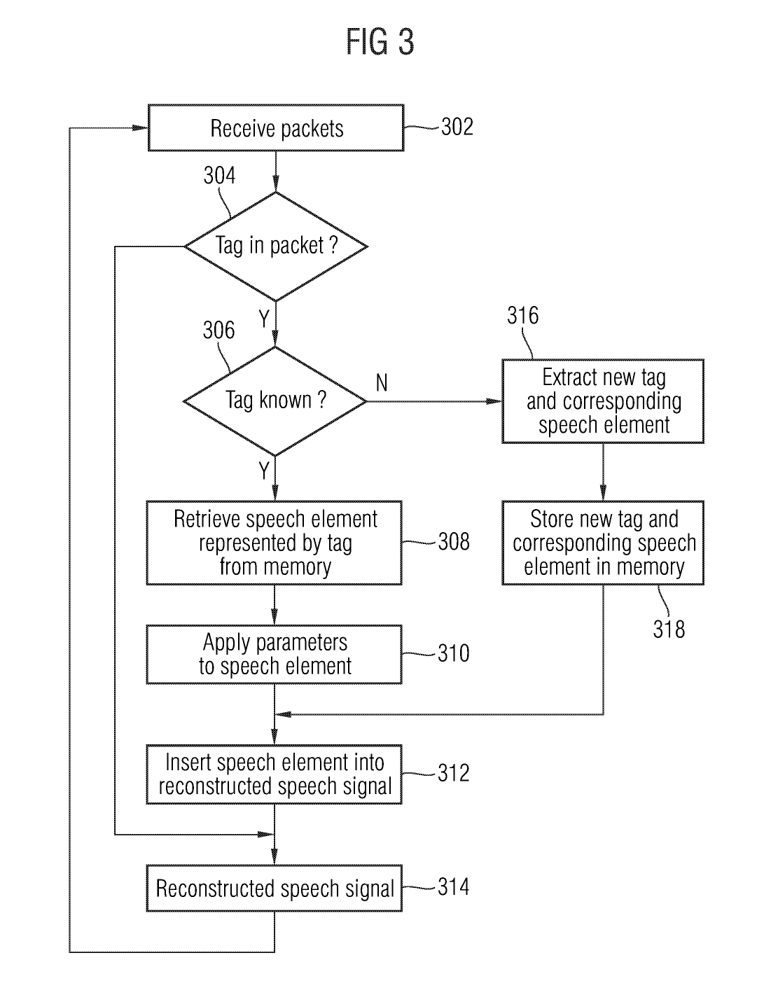

FIG. 3 is a flow diagram of the operation of a decoder in accordance with a preferred embodiment of the present invention.

In FIG. 1, there is shown a network arrangement 100 comprising subscriber terminals 102, 112, switching equipment 104, 108, 116, a packet network 110, and coding/decoding devices 108, 118.

Arrows 120-128 schematically indicate a bearer setup from first terminal 102 to second terminal 112. After passing sections 120, 122, the bearer is routed via first switch 106 comprising first coding/decoding device 108. Along sections 120, 122 any known coding technique may be employed including, but not limited to ITU-T G.711. First coding/decoding device 108 will apply the inventive method and forward the encoded speech signal across packet network 110 (section 124, 126) to second switch 116 comprising second coding/decoding device 118. Second coding/decoding device 108 will apply an inverse transformation of the method applied by first coding/decoding device 108 and forward the reconstructed speech signal across section 128 to second terminal 112, again using any known coding technique including, but not limited to ITU-T G.711.

With reference to FIG. 2, the encoding method employed in coding/decoding devices 108, 118 will now be explained in more detail. In step 202, the discrete time speech signal is received as a continuous bit stream. In step 204, speech elements are identified. Speech elements may for example be chosen to be words, syllables, or phonemes. In the sentence “I have an idea.”, there is a first occurrence of the word/syllable “i” in “I”. “i” will be chosen in step 204 as a first speech element. In step 206 it will be determined whether the speech element chosen in step 204 was chosen before, that is, it will be determined if a tag was already assigned to this speech element. Since no tag is yet assigned to “i”, the method continues in step 208 with creating a unique tag representing the speech element “i” and storing it in a memory of encoding device 108. The tag is then transmitted along with the speech element “i” in step 210.

It shall be noted that in addition to encoding the speech signal in accordance with the inventive method, other encoding or transcoding methods may be employed for speech elements that are not encoded by the invention, and/or for encoding or transcoding the initial transmission of a tagged speech element. For example, encoding device 108 of FIG. 1 may receive a G.711 encoded speech signals and may forward G.723 encoded speech signals which are additionally encoded by the inventive method.

Returning to FIG. 2, after transmitting the tag along with the speech element “i” in step 210 the method returns to step 204 for identifying the next speech element. The next speech element determined by step 204 to have a repetition likelihood exceeding a certain threshold likelihood is the phoneme “a” in the word “have”. The process of steps 204-210 is repeated for “a”, and a second unique tag is assigned to the phoneme “a” as a result. The remaining portions of the word “have” are not used as speech elements in this example and will be transmitted transparently by the method.

The method then continues analyzing the speech signal and identifies another occurrence of “a” in the word “an” in step 204. In step 206 it will be determined that “a” was previously identified and tagged. The method will then continue by accessing the memory and obtaining the tag representing “a”. The speech samples representing “a” will be removed from the bit stream and the tag representing “a” will be transmitted instead in step 214. Since the tag is much shorter than the bit stream representation of “a”, the method thereby achieves a compression of the speech signal. Again, the remaining portions of the word “an” are not used as speech elements in this example and will be transmitted transparently by the method.

The method will then continue analyzing the speech signal and identify another occurrence of “i” in the word “idea”. In step 206 it will be determined that “i” was previously identified and tagged. The method will then continue by accessing the memory and obtaining the tag representing “i”. The speech samples representing “i” will be removed from the bit stream and the tag representing “i” will be transmitted instead in step 214. Again, the remaining portions of the word “idea” are not used as speech elements in this example and will be transmitted transparently by the method.

At the receiving end of the transmissions of an encoding device 108 operating in accordance with the invention, a decoding device 118 may operate as explained in the following with reference to FIG. 3. Decoding device 118 receives packets comprising encoded speech and/or tags representing speech elements in step 302. In step 304 a determination is made whether a tag was received. If not, then the method simply inserts the received speech samples into the reconstructed speech signal, arriving at a reconstructed speech signal section 314, and continues to receive packets in step 302.

If however a tag was received then a determination is made in step 306 whether the received tag is a known tag, for example by querying a memory. If the received tag is not known, then it should be accompanied by a speech element. The new tag and the new speech element are extracted from the packet(s) in step 316 and stored in memory for future use. The method continues by inserting the newly received speech element into the reconstructed speech signal in step 312, arriving at a reconstructed speech signal section 314, and continues to receive packets in step 302.

If in step 306 it is determined that a known tag was received, then the method retrieves the speech element represented by the received unique tag from the memory in step 308 and optionally applies parameters in step 310. The method continues by inserting the speech element into the reconstructed speech signal in step 312, arriving at a reconstructed speech signal section 314, and continues to receive packets in step 302.

It will be readily apparent to those with skills in the art that in addition to decoding the speech signal in accordance with the inventive method, other decoding or transcoding methods may additionally/subsequently be employed. For example, decoding device 118 of FIG. 1 may initially produce a reconstructed speech signal encoded in accordance with G.723 and may forward a G.711 encoded speech signal along path 128 towards terminal 112.

In order to allow a more natural reproduction of speech in decoder 118, tag parameters may be determined in encoder 108 and transmitted along with the tag itself to decoder 118 for use in optional step 310 of FIG. 3. Such parameters may include an identification of the originating device, e.g. terminal 102, or a user thereof; the loudness at which the speech sample represented by the tag was uttered; any leading and/or trailing delays the speech element represented by the tag is subjected to; and a duration (or length indication) of the speech element represented by the tag in order to facilitate shorter or longer versions of the same utterance.

In embodiments, the invention may provide a tag-start and a tag-end indication to allow speech elements associated with a single tag to extend over multiple IP/RTP packets.

In embodiments, an acknowledgement procedure may be implemented for the tag transmission. For example, on reception of a complete speech element, which may be distributed over multiple IP/RTP packets, the receiving decoder 118 shall acknowledge the status of the received element. A positive acknowledgement “ACK” shall indicate the decoder's readiness to use the tag as representation for the speech element from thereon. A negative acknowledgement “NACK”, or (implementation dependent) an absence of as positive acknowledgement “ACK”, may indicate to originating encoder 108 to drop that particular tag. Retransmission is not recommended, particularly for longer speech elements.

It shall be noted that the present invention does not require a full speech-to-text analysis and therefore allows the language-independent deployment of the invention.

While in the preferred embodiments the encoding/decoding devices 108, 118 have been shown to be part of the telecommunications network, other embodiments may provide for terminals 102, 112 comprising the means for applying the inventive encoding and/or decoding scheme to speech signals. When implemented as part of the telecommunications network, the encoding/decoding devices may for example be implemented in or in close association with switches or gateways.

To conserve memory in the encoding and decoding devices, tags that have not been used for a configurable amount of time may optionally be deleted. For that, each tag and its associated speech element may be statistically monitored.

Additionally the tags can be enhanced to identify the individual for whom speech elements and tags were created and stored in memory during a voice call. In this way, the tags can be stored in recipient device so that in a new connection, if the individual is identified, his/her tags can be reused. This may require the bidirectional exchange of the already existing known tags and their imprints without content at the beginning of a new voice connection. Alternatively, the tags on the recipient device can be deleted after the voice call was released.

While the present invention has been described by reference to specific embodiments and specific uses, it should be understood that other configurations and arrangements could be constructed, and different uses could be made, without departing from the scope of the invention as set forth in the following claims.

1. A method for encoding a discrete time speech signal, comprising:
identifying a speech element in the speech signal;
if the speech element is identified for a first time:
creating a unique tag representing the speech element;
creating an association between the speech element and the unique tag in a memory;
transmitting the speech element in discrete time form and the tag and an indication that the tag is to represent the speech element; and
if the speech element is not identified for the first time:
obtaining a unique tag representing the speech element from the memory,
removing the speech element from the speech signal, and
transmitting the unique tag representing the speech element as obtained from the memory.

2. The method of claim 1, wherein the tag representing the speech element comprises parameters indicating at least one of the following:
loudness of the represented speech element;
leading and/or trailing delay for reinserting the speech element into the discrete time speech signal;
a length indication indicating whether the full speech element or a fraction thereof is to be reinserted into the discrete time speech signal; and
an identifier identifying a speaker or an encoding device.

3. The method of claim 1, wherein the speech element comprises at least one of the following: entire words; syllables; and phonemes.

4. The method of claim 1, further comprising purging a tag from memory that has not been in use for a configurable amount of time.

5. In a telecommunications network, a network element to perform the following:
identifying a speech element in the speech signal;
if the speech element is identified for a first time:
creating a unique tag representing the speech element;
creating an association between the speech element and the unique tag in a memory;
transmitting the speech element in discrete time form and the tag and an indication that the tag is to represent the speech element; and
if the speech element is not identified for the first time:
obtaining a unique tag representing the speech element from the memory,
removing the speech element from the speech signal, and
transmitting the unique tag representing the speech element as obtained from the memory.

6. A user terminal attachable to a telecommunications network to perform the following:
identifying a speech element in the speech signal;
if the speech element is identified for a first time:
creating a unique tag representing the speech element;
creating an association between the speech element and the unique tag in a memory;
transmitting the speech element in discrete time form and the tag and an indication that the tag is to represent the speech element; and
if the speech element is not identified for the first time:
obtaining a unique tag representing the speech element from the memory,
removing the speech element from the speech signal, and
transmitting the unique tag representing the speech element as obtained from the memory.

7. A method for decoding an encoded speech signal, the encoded speech signal encoded in accordance with the method of claim 1, comprising:
determining if a received signal section comprises a tag,
if no tag is received, inserting the signal section into the reconstructed speech signal;
if the tag is identified for a first time:
extracting a corresponding speech element from the signal section;
creating an entry in a memory for the tag and the corresponding speech element; and
inserting the speech element into the reconstructed speech signal;
if the tag is already residing in memory:
extracting a corresponding speech element from the memory; and
inserting the speech element into the reconstructed speech signal.

8. The method of claim 7, wherein the tag representing the speech element comprises parameters indicating at least one of the following:
loudness of the represented speech element;
leading and/or trailing delay for reinserting the speech element into the discrete time speech signal;
a length indication indicating whether the full speech element or a fraction thereof is to be reinserted into the discrete time speech signal; and
an identifier identifying a speaker or an encoding device, wherein an operation applying the parameters to the speech element is performed before inserting the speech element into the reconstructed speech signal.

9. The method of claim 7, further comprising purging a tag from memory that has not been in use for a configurable amount of time.

10. In a telecommunications network, a network element having to perform:
determining if a received signal section comprises a tag,
if no tag is received, inserting the signal section into the reconstructed speech signal;
if the tag is identified for a first time:
extracting a corresponding speech element from the signal section;
creating an entry in a memory for the tag and the corresponding speech element; and
inserting the speech element into the reconstructed speech signal;
if the tag is already residing in memory:
extracting a corresponding speech element from the memory; and
inserting the speech element into the reconstructed speech signal.

11. A user terminal (102, 112) attachable to a telecommunications network to perform the following:
determining if a received signal section comprises a tag,
if no tag is received, inserting the signal section into the reconstructed speech signal;
if the tag is identified for a first time:
extracting a corresponding speech element from the signal section;
creating an entry in a memory for the tag and the corresponding speech element; and
inserting the speech element into the reconstructed speech signal;
if the tag is already residing in memory:
extracting a corresponding speech element from the memory; and
inserting the speech element into the reconstructed speech signal.
